(19) United States
(12) Patent Application Publication
(10) Pub. No.: US 2026/0361398 A1
(43) Pub. Date: Nov. 12, 2026

(54) SYSTEMS AND METHODS FOR MOBILITY MANAGEMENT OF TERRESTRIAL NETWORK (TN), NON-TERRESTRIAL NETWORK (NTN), AND SUPPLEMENTAL COVERAGE FROM SPACE (SCS) RESOURCES

(71) Applicant: AALYRIA TECHNOLOGIES, INC., LIVERMORE, CA (US)

(72) Inventors: STEFAN DRASKOCI, LONDON (GB); BRIAN BARRITT, PITTSBURGH, PA (US); LUCA LODIGIANI, LONDON (GB)

(21) Appl. No.: 19/666,223

(22) Filed: May 2, 2026

Related U.S. Application Data
(60) Provisional application No. 63/886,581, filed on Sep. 23, 2025.
(60) Provisional application No. 63/801,286, filed on May 7, 2025.

(51) Int. Cl. H04B 7/185

(52) U.S. Cl. CPC H04B 7/18541; H04B 7/1855; H04B 7/18589

(57) ABSTRACT

The current disclosure utilizes a radio access network controller to facilitate mobility management for user equipment between terrestrial networks and nonterrestrial networks. User equipment corresponding to one or more first responders may be given priority.

### CROSS REFERENCE TO RELATED APPLICATIONS

This U.S. Non-Provisional Application claims the benefit of priority U.S. Provisional Application Number 63/886,581, filed Sept. 23, 2025; and also claims the benefit of priority U.S. Provisional Application Number 63/801,286, filed May 7, 2025, the disclosures of which are incorporated by reference herein in their entirety.

### BACKGROUND

Mobile telecommunication networks may provide wireless connectivity that may enable voice, data, and/or Internet services for mobile devices across wide geographic areas. Terrestrial networks may provide the ground-based infrastructure (e.g., cell towers, antennas, and/or fiber links) that may enable mobile devices to connect to the broader telecommunications system. Gaps in connectivity may exist where the deployment of terrestrial base stations has proven to be physically infeasible or commercially unavailable. Proprietary satellite systems may be utilized to serve such remote regions, however these have in most cases proven to be too inaccessible and impractical to the end user to see widespread adoption.

The 3GPP family of standards for mobile networks has achieved global adoption and usage and has given rise to billions of mobile devices which support a number of generations of the standard (3G, 4G, 5G, etc.). The combination of these standards with the ubiquitous reach of satellites presents a compelling solution to deliver connectivity to unconnected regions and people.

This opportunity was recognized in 3GPP and has been actively addressed in recent years as a new flavor of the 5G new radio (NR) standard, called 5G Non-Terrestrial Networks (NTN). Non-Terrestrial Networks may utilize spaceborne (e.g., satellites), airborne (e.g., drones or balloons), or other non-ground-based platforms to act as a repeater of a 5G waveform which may be generated on the ground. In an example, Low Earth Orbit (LEO) satellite constellations may be the preferred mode of delivery (e.g., via earth-fixed cells or satellite-fixed cells). In this example, a 5G next generation Node B (gNodeB or gNB) Radio Access Network (RAN) stack may generate a downlink (DL) NR-Uu waveform that may be transmitted by a NTN gateway to the LEO satellite(s) via a feeder link, where the NR-Uu waveform may be repeated, typically on another frequency, and retransmitted down to a terrestrial mobile device, a user equipment (UE), on a service link. In contrast, an uplink NR-Uu waveform may follow a reverse path, being transmitted by the UE via the service link to the LEO satellite(s), where the signal is retransmitted via the feeder link down to the NTN gateway and 5G gNodeB RAN.

In some examples, RAN components may be proprietary or tightly integrated by a single vendor. In other examples, such as an Open Radio Access Network (O-RAN), the RAN may be split into modular components that may come from different vendors. The O-RAN may include a radio unit to handle radio frequency transmissions and reception. A Service Management and Orchestration (SMO) may be a component in the O-RAN architecture responsible for managing or orchestrating the lifecycle of RAN components (e.g., gNBs, RIC Applications (rApp), or extensible applications (xApp)); provisioning, monitoring, or optimizing network functions; hosting rApps; or interfacing with operations support systems or other management systems. The O-RAN may further include a distributed unit to process real-time data like scheduling or beamforming. The O-RAN may further include a central unit and RAN Intelligent Controller (RIC). In some examples, the RIC may include a Near-Real-Time (RT) RIC and/or a Non-RT RIC. In these examples, the Near-RT RIC may enable real-time control. The non-RT RIC may enable long-term optimization or policy management. The use of open interfaces may enable the equipment from different vendors to work together. An RIC Application (rApp) may run on the Non-RT RIC to enable policy management, machine learning model training, network optimization, long term analytics or other functions.

Subsequent releases of 3GPP may tackle the complexities of hosting a 5G gNodeB onboard satellites and having the capability to route traffic flows over Inter-Satellite Links (ISLs) to other satellites. These kinds of networks may offer greater flexibility to the end-to-end delivery of connectivity, but in doing so they may also increase operational complexity. Over time, Direct-to-Device 5G NTN services will evolve towards being capable of delivering higher data rates to the UE(s) to support different services.

The market is trending towards 5G NTN constellations being owned and operated by incumbent and emerging Satellite Network Operators (SNOs), who are distinct to the terrestrial Mobile Network Operators (MNOs) whose coverage gaps they are filling. Supplemental Coverage from Space (SCS) may provide an example in which SNO coverage may fill coverage gaps in the MNO coverage. Each independent 5G NTN constellation is intended to act as a logical extension of a number of 5G terrestrial networks all over the world, where the mobile devices are expected to roam onto the former in the absence of the latter. The end goal is to enable mobile users to consume connectivity services with minimal impact on their perceived experience, including seamless transitions/handovers between 5G Terrestrial Networks (TNs) and 5G NTNs. A key challenge in achieving this end goal is that the current 3GPP standards do not sufficiently address the architectural implementations and processes by which 5G TNs and NTNs will integrate and coordinate at the RAN and Core levels, to allow mobile devices (UEs) to be seamlessly handed over from one to the other.

Terrestrial network coverage gaps are in some cases quite wide, while in other cases significantly smaller. A UE driving on a highway might leave, re-enter, and again leave the terrestrial coverage area every couple of minutes. In order to assure seamless consumption of connectivity services, the network should be capable of maintaining voice and data-based conversations (e.g., WhatsApp) during the handovers between the TN and the NTN. In handover events between terrestrial base stations, this is achieved either by having an interface between the two gNodeBs which allows them to coordinate (e.g., the Xn interface), or by having them do so via their common Core Network (e.g., via the Next Generation (NG) interface). The establishment of this kind of interfacing on a global scale between the SNOs and various MNOs would be very difficult to achieve. As such, another key challenge is that current 3GPP standards for 5G NTN account for traditional mobile roaming between operators as being the handover procedure for transitions between the two, which would pose a significant interruption for a user to their consumption of connectivity services.

There are new NTN control plane signaling measures that were introduced by 3GPP to aid UEs for the initial access and mobility procedures, such as the System Information Block 19 (SIB19). These are intended to be unicast or broadcast by the TN RAN to UEs which are soon to be connected to the NTN network. The UEs use this information about their target satellite to properly synchronize in time and frequency with the NTN segment, to facilitate TN-to-NTN handover. In integrated TN and NTN environments, maintaining seamless coverages is challenged by dynamic conditions that may introduce or exacerbate coverage gaps within or between the two domains. Factors such as atmospheric interference, terrain obstructions, and satellite beam transitions can disrupt connectivity. These disruptions may necessitate mechanisms for proactive planning and real-time awareness to ensure continuity in network coverage. These mechanisms may include systems or methods to anticipate, detect, or respond to coverage gaps between TN and NTN, including SCS, to maintain reliable communication across diverse contexts.

In inter-domain or inter-operator environments, 5G and/or 4G LTE may not be feasible due to limited signaling of neighbor relationships for measurement configurations. In some examples, an NTN may not be aware of a UE in TN that is about to be handed over to the NTN. In those examples, NTN coverage may not be active in the target area to support the UE. In some examples, UE capability signaling may be heavy, which may adversely impact NTN capability.

### SUMMARY

The current disclosure may utilize NTN resources to facilitate mobility management of user equipment between terrestrial network cells and nonterrestrial network cells. In some examples of the present disclosure, the NTN may include supplemental coverage from space.

In a first aspect, a method is provided for managing mobility of one or more user equipment between one or more TN and one or more NTN. The method includes the steps of: (A) detecting one or more TN cells and one or more NTN cells; (B) modeling TN coverage cell topology and configuration; (C) detecting one or more user equipment (UE); (D) after detecting the one or more UEs, detecting a trajectory of the one or more UEs; at (E), the disclosed method may include a determination of the location of the one or more UEs.

In an example aspect, in accordance with a determination that the one or more UEs are in a TN cell, exiting the TN cell, and entering an NTN cell: (F) designating the one or more UEs as candidates for a handover to the NTN; (G) after designating the one or more UEs as candidates for the handover to the NTN, reporting one or more candidate NTN cells to the terrestrial network, wherein reporting the one or more candidate NTN cells to the TN includes reporting one or more positions and movement of one or more NTN satellites; (H) after reporting the one or more candidate NTN cells to the TN and upon a determination that the one or more UEs are entering an area corresponding to the one or more candidate NTN cells, configuring one or more cell measurement targets in the one or more UEs, activating the one or more NTN cells to provide network coverage for the one or more UEs; triggering a handover of the one or more UEs from the TN to the NTN; and providing network coverage for the one or more UEs using the one or more candidate NTN cells.

In another example aspect, in accordance with a determination that the one or more UEs are in an NTN cell and in accordance with a determination that the trajectory of the one or more UEs will cause the one or more UEs to exit the NTN cell and enter a TN cell: (I) designating the one or more UEs as candidates for a handover to the TN; (J) after designating the one or more UEs as candidates for the handover to the TN, reporting one or more candidate TN cells to the NTN, wherein reporting the one or more candidate TN cells to the NTN includes reporting one or more positions of one or more TN base stations; (K) configuring the one or more candidate cells based on synchronization signal block measurement timing configuration based on the one or more UEs; (L) upon a determination that the one or more UEs are entering an area corresponding to the one or more candidate TN cells, triggering a handover of the one or more UEs from the NTN to the TN, and providing network coverage for the one or more UEs using the one or more candidate TN cells.

### DESCRIPTION OF THE DRAWINGS

FIG. 1A is a diagram of an example telecommunications network in accordance with an example of the present disclosure.

FIG. 1B is a diagram of an example telecommunications network in accordance with an example of the present disclosure.

FIG. 1C is a diagram of an example telecommunications network in accordance with an example of the present disclosure.

FIG. 2 illustrates an example flowchart illustrating operations for managing mobility of one or more UEs between one or more TN and one or more NTN in accordance with an example of the present disclosure.

The details above in the Brief Description of the Drawings are intended to describe only some aspects relating to certain embodiments of the innovations herein and should not be deemed in any way limiting with respect to requiring or omitting any aspect for embodiments to be claimed or otherwise limiting the disclosure or embodiments keeping with its scope or spirit.

### DETAILED DESCRIPTION

Telecommunications network coverage may be limited for one or more UEs that may require a handoff from a TN to an NTN, or vice versa. At times, the NTN may not be aware of the UE that may be handed over to the NTN from a TN. In some examples, NTN coverage may not be active. In other examples, the NTN may have an insufficient duty cycle or capacity to cover the UE. The NTN may further lack awareness of the incoming load, quality of service (QoS) requirements, and/or UE capabilities. In some 3GPP releases, synchronization signal block (SSB) periodicity may be relaxed, which may adversely impact UE sync performance and/or reliability.

In some cases, the TN may not be aware of neighbor NTN cells, especially for candidate cells that may not be active. In these examples, the TN may lack awareness of target NTN cell configuration, which may include measurements required for configuration, handoff triggers, and/or reselection policies. In some examples, the TN may not be aware of satellite ephemeris, which may impact handoff between the TN and NTN. In some examples, radio link failure (RLF), UE detach, network selection, and/or access from scratch may create service interruption and/or unnecessary signaling load.

In other examples, as noted, a UE may need to be handed over from an NTN to a TN. The disclosed subject matter may enable mobility management of one or more UEs as the one or more UEs move from an NTN to a TN. In some examples of the present disclosure, an NTN may not be aware of candidate neighbor TN cells for hand-off of the one or more UEs to the TN cells. In these examples, the NTN may lack awareness of one or more target TN cell configurations for measurement configurations and/or handoff triggering. The disclosed subject matter may enable mobility management for one or more UEs in some cases when the NTN may lack awareness of a preferred cell and/or band selection policy from a target MNO. In an example aspect, the NTN may lack awareness of load and/or possible target cell congestion.

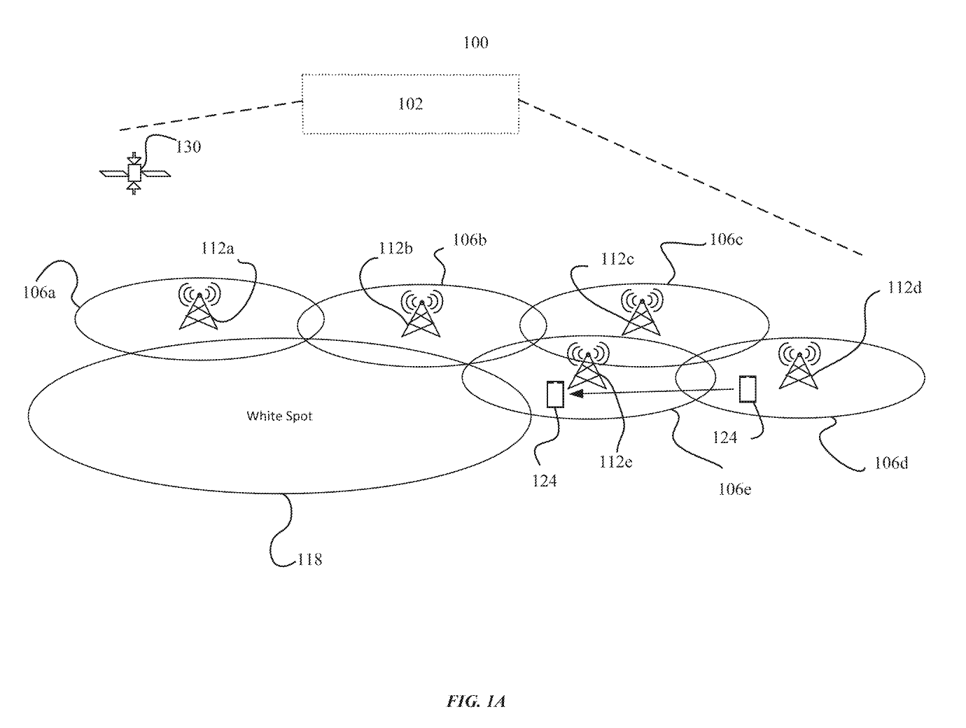

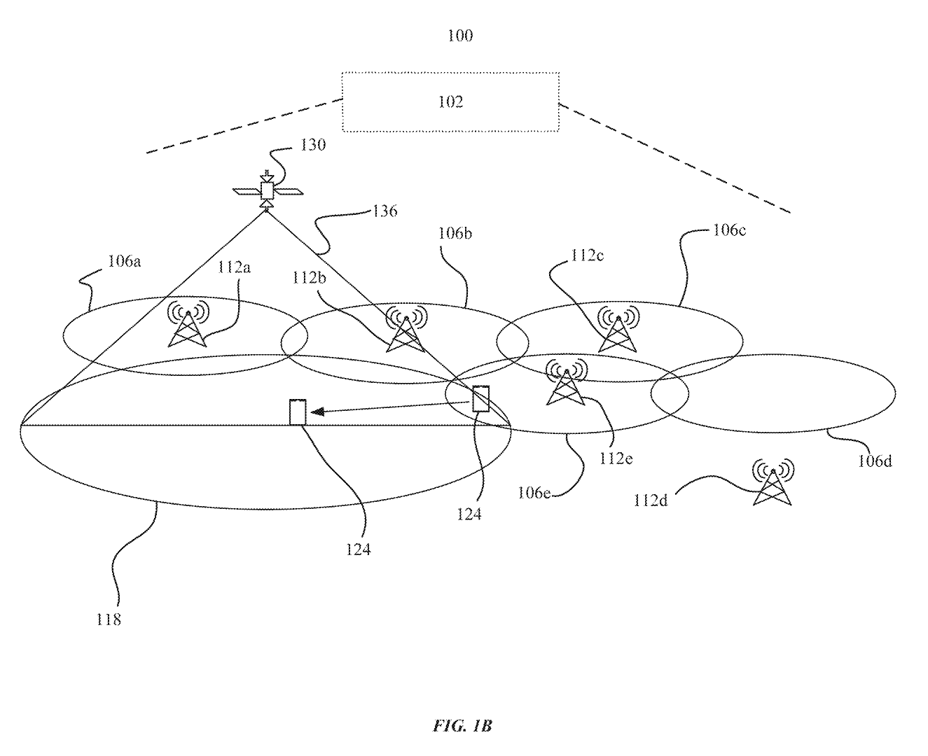

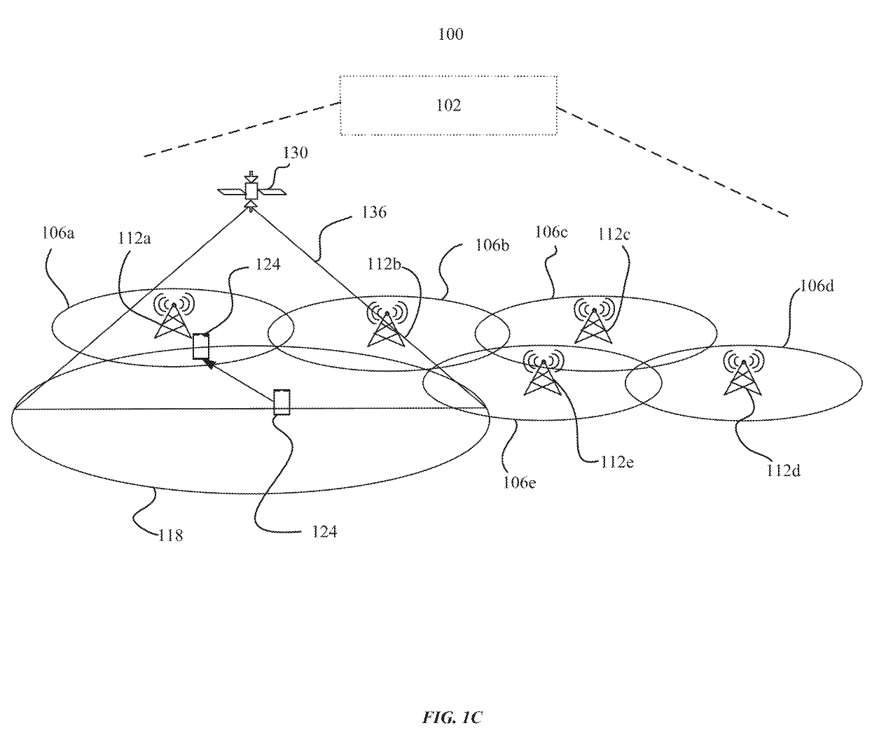

FIGS. 1A-1C illustrate an example network 100 in accordance with an example of the present disclosure. As illustrated in FIGS. 1A-1C, network 100 may be a telecommunications network. For example, network 100 may provide 4G LTE coverage for one or more devices. For another example, network 100 may provide 5G coverage for one or more devices. As illustrated in FIGS. 1A-1C, network 100 may include a TN and an NTN. It should be recognized that network 100 is not limited to including both a TN and NTN. For example, network 100 may include a TN with no NTN coverage. For another example, network 100 may include an NTN with no TN coverage. As illustrated in FIGS. 1A-1C, network 100 may include controller 102. At FIGS. 1A-1C, controller 102 may include an SMO framework that may be configured to manage TN and NTN, including those that may be operated by SNOs. In some examples, controller 102 may be configured to perform one or more functions of a Non-RT RIC and/or Near-RT RIC. At FIGS. 1A-1C, controller 102 may include a solver configured to optimize an NTN, process inputs from a network, and/or support RIC application (rApp) or extensible applications (xApp). In some examples, the solver may be part of an artificial intelligence (AI) decision-making loop. AI, machine learning (ML) models, large language models (LLM), and neural networks (NN) may be used interchangeably herein. For example, the solver may use ML models trained on historical and/or simulated NTN data. For another example, the solver may run optimization algorithms. At FIGS. 1A-1C, controller 102 may be configured to determine neighbor relationships between TN cells and NTN cells. In some examples, the TN may advertise neighbor relationships to controller 102. At FIGS. 1A and 1B, controller 102 may model network 100, which may include coverage provided by the TN and NTN. In some examples, the NTN may be a SCS network.

As illustrated in FIGS. 1A-1C, the TN may include base stations 112a-112e. It should be recognized that the TN may include more or less base stations than base stations 112a-112e. For example, the TN may include three base stations. For another example, the TN may include 20 base stations. Base stations 112a-112e may perform similar functions and may be used interchangeably herein. In some examples, base station 112a may include radio equipment, antennas, power supplies, and/or backhaul connections. As illustrated in FIGS. 1A-1C, the TN may further include network cells 106a-106e. In some examples, network cells 106a-106e may be geographical areas that may be provided with coverage from base stations 112a-112e. For example, base station 112a may provide coverage to network cell 106a. For another example, base station 112b may provide coverage to network cell 106b. It should be recognized that network cells 106a-106e may perform similar functions and may be used interchangeably herein. It should be further recognized that the TN may include more or less than network cells 106a-106e. For example, the TN may include 20 network cells. It should be recognized that base station 112a may provide coverage for more than just network cell 106a. For example, base station 112a may provide coverage for network cells 106a-106c. For another example, base station 112d may provide coverage for network cells 106b-106e. At FIGS. 1A-1C, the TN may include an rApp in that may be configured to collect information and relay the information to the TN.

As illustrated in FIGS. 1A -1C, the NTN may include platform 130. In some examples, the NTN includes supplemental coverage from space (SCS). For example, platform 130 may include a LEO satellite. In other examples, the NTN may include one or more airborne components. For example, platform 130 may include an unmanned aerial vehicle (UAV). At FIGS. 1A-1C, platform 130 may be used to provide coverage for network cell 106a. It should be recognized that the NTN may include more platforms than platform 130. For example, the NTN may include 16 platforms. At FIGS. 1A and 1C, controller 102 may detect a constellation of satellites in a telecommunications network that may include platform 130. In some examples, controller 102 may be utilized to coordinate the deployment of platform 130. At FIGS. 1A-1C, controller 102 may determine and/or report one or more NTN cells. In some examples, reporting the one or more NTN cells may include reporting NTN satellite positions and movement. As illustrated in FIGS. 1A-1C, the TN may provide coverage for user equipment (UE) 124. At FIGS. 1A-1C, UE 124 may be a UE at a first position at a first time, and then UE 124 may transit to a second position at a second time. At FIGS. 1A-1C, movement from the first position to the second position may be illustrated by an arrow pointing from UE 124 at the first position to UE 124 at the second position. In some examples, UE 124 may include one or more consumer devices (e.g., smartphones, tablets, laptops, and/or wearables), fixed wireless devices (e.g., home routers and/or satellite terminals), Internet of Things (IoT) or Machine-to-Machine (M2M) devices (e.g., smart meters, connected vehicles, industrial sensors, and/or asset trackers), industrial equipment (e.g., ruggedized handhelds, private network terminals, and/or mission-critical communication devices), and/or specialized equipment (e.g., drones with cellular or satellite connectivity, augmented or virtual reality headsets, and/or medical devices with telemetry features). At FIGS. 1A-1C, controller 102 may model a constellation of the NTN to construct a beam layout plan that may take into account dynamic changes in slant range and/or orbit precession. In some examples, the constellation may include antennas and signal propagation.

At FIGS. 1A-1C, controller 102 may map coverage topology of the terrestrial cells (e.g., network cells 106a-106b as part of the TN) to enable dynamic provisioning of NTN resources in designated white spots (e.g., white spot 118 from FIG. 1A) according to a model plan. For example, controller 102 may deploy platform 130 to a designated white spot (e.g., white spot 118). At FIGS. 1A-1C, after mapping the TN, controller 102 may determine a telecommunications network coverage provided by network cells 106a-106e (e.g., the terrestrial network). At FIGS. 1A-1C, controller 102 may determine a beam layout plan to utilize platform 130 to provide network coverage to one or more areas (e.g., network cells 106a-106e). In some examples, the beam layout may include one or more areas that beams (e.g., beam 136 from FIGS. 1B and 1C) from satellites (e.g., platform 130) in a constellation may cover. In some examples, the beam layout plan may be based on a slant range, orbit precession, beam shape, beam size, beam center, beam direction, or antenna patterns. At FIGS. 1A-1C, controller 102 may control and/or configure the ground segment (e.g., the TN), a RAN for Long-Term Evolution (LTE) (e.g., 4G), 5G, and the space segment (e.g., NTN) in a coordinated time-space-aware fashion. In this way, the controller 102 may track how different coverage areas (e.g., satellite beams or network cells) may overlap or shift over time or geography. This may enable determination of where or when coverage may be available or missing. In some examples, controller 102 may utilize O-RAN control primitives and configuration primitives alongside non-O-RAN and/or non-3GPP mechanisms to enact on the end-to-end communications chain. At FIGS. 1A-1C, controller 102 may model weather. In some examples, controller 102 may predict dynamic effects from weather or other conditions. At FIGS. 1A-1C, controller 102 may further provide up-to-date NTN cell ephemeris information

FIGS. 1A and 1B illustrate an example of mobility management for a UE transiting from a TN to an NTN. As illustrated in FIG. 1A, UE 124 may be at a first position, corresponding to network cell 106d, at a first time. At FIG. 1A, base station 112d may provide network coverage for UE 124 while UE 124 is in network cell 106d. As illustrated in FIG. 1A, UE 124 may move to a second position, corresponding to network cell 106e, at a second time. At FIG. 1A, base station 112e may provide network coverage for UE 124 while UE 124 is in network cell 106e. In this way, the TN may support the mobility of UE 124 between one or more network cells while UE 124 transits between the one or more network cells that are a part of the TN (e.g., network cell 106a-106e). In some examples, UE 124 may be associated with an entity or organization that may be prioritized in the TN or NTN. For example, UE 124 may be associated with one or more first responders.

At FIG. 1A, white spot 118 may be a geographic area that may represent a coverage gap within or between network cells 110a-110e. In some examples, white spot 118 may be caused by geographic obstacles. For example, one or more mountains may block coverage from base stations 120a-120e to white spot 118. In other examples, white spot 118 may be caused by infrastructure limitations. For example, outdated or insufficient base stations may not be able to provide coverage to white spot 118. At FIG. 1A, controller 102 may detect white spot 118. As illustrated in FIG. 1A, controller 102 may deploy platform 124 to provide coverage for white spot 118. In this way, the NTN may provide coverage for a geographic area that may not be covered by the TN. For example, platform 124 may make up for a gap in coverage due to a physical obstacle (e.g., mountain) that may prevent coverage for white spot 118 from base station 120a.

At FIG. 1A, when UE 124 moves to the second position at the second time, UE 124 may be approaching white spot 118. At FIG. 1A, NTN coverage of white spot 118 may not be active. At FIG. 1A, an interface between the TN and NTN may act as av network proxy by dynamically advertising neighbor relationships between the TN and the NTN. As illustrated in FIG. 1A, the interface may advertise that network cell 106a, network cell 106b, and network cell 106e border white spot 118. At FIG. 1A, controller 102 may maintain a dynamic model of a TN coverage edge cell topology and configuration. In this way, controller 102 may be aware of the locations of network cells 106a-106e, base stations 112a-112e, and white spot 118.

At FIG. 1A, based on UE 124 approaching white spot 118, controller 102 may identify UE 124 as a candidate for handing out to the NTN. In some examples, controller 102 may make a determination of whether UE 124 is a candidate for handing out to the NTN may further be based on a mobility pattern and/or trajectory of UE 124. At FIG. 1A, controller 102 may make the determination of whether UE 124 is a candidate for handing out to the NTN based on information provided to controller 102 by the TN. At FIG. 1A, a last known location and/or trajectory of UE 124 may be communicated from the TN to controller 102. In some examples, controller 102 may provide advertisements of active or possible candidate NTN neighbor cells from the NTN to the TN. For example, controller 102 may advertise to the TN that platform 130 may provide coverage for UE 124 in white spot 118. In this way, controller 102 may enable mobility of UE 124 from network cell 112e to white spot 118. At FIG. 1A, controller 102 may receive one or more incoming load and/or QoS requirements form the TN. Controller 102 may further receive one or more capabilities of UE 124 from the TN. In this way, controller 102 may configure the NTN to provide adequate resources for UE 124.

At FIG. 1B, upon a determination that UE 124 may move from the second position, which may correspond to network cell 106e, to a third position, which may correspond to white spot 118, controller 102 may activate platform 130 to provide NTN coverage for white spot 118. At FIG. 1B, upon activation of platform 130 for providing coverage for white spot 118, a network cell corresponding to white spot 118 may be activated. As illustrated in FIG. 1B, platform 130 may provide coverage for the network cell corresponding to white spot 118 using beam 136. In some examples, controller 102 may need to allocate additional resources for coverage of the network cell corresponding to white spot 118. For example, additional resources may include a beam downlink or uplink duty cycle, one or more frequencies, one or more carriers, and/or power allocation. In some examples, controller 102 may configure the NTN cell measurement targets in UE 124 while UE 124 is in the TN. In some examples, the NTN or TN may be providing coverage for white spot 118. In these examples, controller 102 may determine that coverage is being provided for white spot 118 and maintain coverage for, via the TN or NTN, white spot 118. As illustrated in FIG. 1B, UE 124 may move from the second position to a third position at a third time. At FIG. 1B, in response to detecting UE 124 at the third position and upon a determination that the third position is in white spot 118, controller 102 may initiate a handover of UE 124 to platform 130 for coverage. In some examples, controller 102 may trigger a handover or conditional handover from the TN to the NTN. At FIG. 1B, SSB periodicity may be increased to improve UE synchronization, measurement performance, and/or reliability.

FIG. 1C illustrates an example of mobility management for a UE transiting from an NTN to a TN while maintaining telecommunications network coverage. At FIG. 1C, controller 102 may maintain a dynamic model of the TN coverage edge cell topology and/or configuration (e.g., a map including network cells 106a-106e, base stations 112a-112e, and capabilities of the TN). At FIG. 1C, an rApp may be hosted on an SMO and/or Non-RT RIC in the TN that may collect information and/or relay the information to controller 102 via an interface. In this way, the TN may advertise one or more network cells (e.g., network cells 112a-112e) that may be neighboring a cell that may be covered by the NTN (e.g., a network cell corresponding to white spot 118). The TN may further enable network cell configuration (e.g., SSB measurement timing configuration) and/or handover preparation by controller 102 or a gNB.

As illustrated in FIG. 1C, UE 124 may transit from the third position to a fourth position at a fourth time. As illustrated in FIG. 1C, the third position may be located in white spot 118. At FIG. 1C, controller 102 may have activated a network cell corresponding to white spot 118 to provide network coverage for UE 124 while UE 124 is located in the area inside white spot 118. At FIG. 1C, the fourth position may correspond to a location in network cell 106a. At FIG. 1C, base station 112a may be providing coverage for network cell 106a. At FIG. 1C, the TN may express preferences for handover targets. For example, controller 102 may receive one or more preferences from the TN that may cause controller 102 to hand over UE 124 to base station 112a for coverage while UE 124 is in network cell 106a.

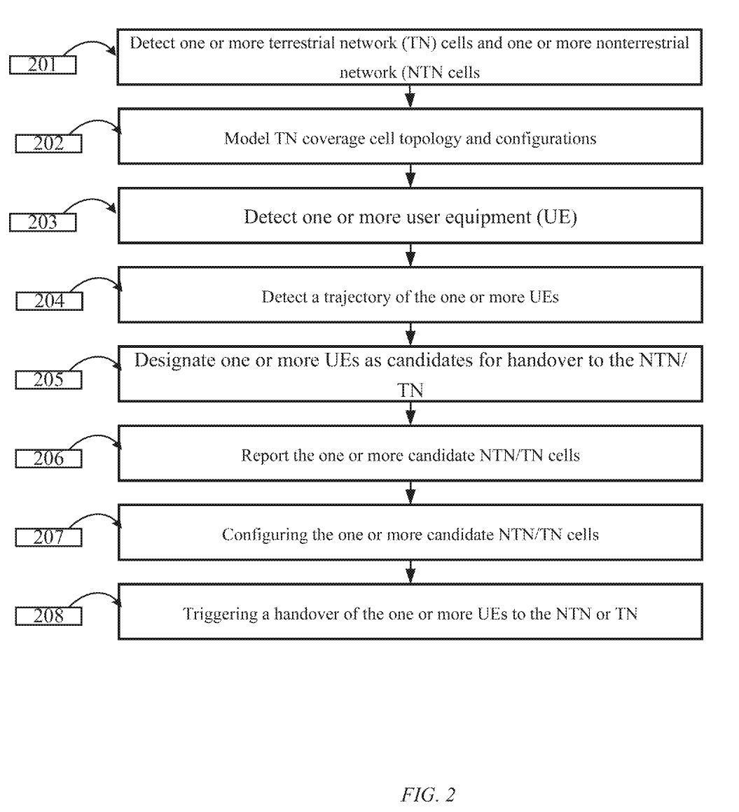

FIG. 2 illustrates a flowchart illustrating an example method for managing mobility of one or more UEs between one or more TN and one or more NTN. At operation 201, a network controller (e.g., controller 102) may detect one or more TN cells and one or more NTN cells. At operation 202, the network controller may model TN coverage cell topology and configurations. At operation 203, the network controller may detect one or more UEs. In some examples the one or more UEs may correspond to one or more first responders. At operation 204, after detecting the one or more UEs, the network controller may detect a trajectory of the one or more UEs.

In an aspect, at operation 205, in accordance with a determination that the one or more UEs are in a TN cell and in accordance with a determination that the trajectory of the one or more UEs will cause the one or more UEs to exit the TN cell and enter an NTN cell, the network controller may designate the one or more UEs as candidates for a handover to the NTN. At operation 206, after designating the one or more UEs as candidates for a handover to the NTN, the network controller may report one or more candidate NTN cells to the TN. At operation 207, the network controller may configure the one or more candidate NTN cells and one or more candidate NTN cell measurement targets in the one or more UEs. At step 208, after activating the one or more NTN cells, the network controller may trigger a handover of the one or more UEs from the TN to the NTN. In some examples, the NTN may provide network coverage for the one or more UEs using the one or more candidate NTN cells.

In an alternate aspect, at operation 205, in accordance with a determination that the one or more UEs are in an NTN cell and in accordance with a determination that the trajectory of the one or more UEs will cause the one or more UEs to exist the NTN cell and enter a TN cell, the network controller may designate the one or more UEs as candidates for a handover to the TN. At operation 206, after designating the one or more UEs as candidates for the handover to the TN, the network controller may report one or more candidate TN cells to the NTN. At operation 207, the network controller may configure the one or more candidate TN cells based on synchronization signal block measurement timing configuration based on the one or more UEs. At operation 208, upon a determination that the one or more UEs are entering an area corresponding to the one or more candidate TN cells, the network controller may trigger the handover of the one or UEs from the NTN to the TN. In some examples, the network may provide coverage for the one or more UEs using the one or more candidate TN cells.

1. A method for managing mobility of one or more user equipment (UEs) between one or more terrestrial networks (TN) and one or more nonterrestrial networks (NTN), the method comprising:
detecting one or more TN cells and one or more NTN cells;
modeling, using a network controller, TN coverage cell topology and configurations;
detecting the one or more user UEs;
after detecting the one or more UEs, detecting a trajectory of the one or more UEs;
when the one or more UEs are in a TN cell and when the trajectory of the one or more UEs will cause the one or more UEs to exit the TN cell and enter an NTN cell:
designating the one or more UEs as candidates for a handover to the NTN;
reporting one or more candidate NTN cells to the TN, wherein reporting the one or more candidate NTN cells to the TN includes reporting one or more positions and movement of one or more NTN platforms; and
when the one or more UEs are entering an area corresponding to the one or more candidate NTN cells:
configuring measurement targets of the one or more candidate NTN cells in the one or more UEs;
activating the one or more NTN cells to provide network coverage for the one or more UEs;
triggering the handover of the one or more UEs from the TN to the NTN; and
providing the network coverage for the one or more UEs using the one or more candidate NTN cells;
when the one or more UEs are in the NTN cell and when the trajectory of the one or more UEs will cause the one or more UEs to exit the NTN cell and enter the TN cell:
designating the one or more UEs as candidates for a handover to the TN;
reporting one or more candidate TN cells to the NTN, wherein reporting the one or more candidate TN cells to the NTN includes reporting one or more positions of one or more TN base stations;
configuring the one or more candidate TN cells based on a synchronization signal block measurement timing configuration based on the one or more UEs; and
when the one or more UEs are entering an area corresponding to the one or more candidate TN cells:
triggering the handover of the one or more UEs from the NTN to the TN; and
providing network coverage for the one or more UEs using the one or more candidate TN cells.

2. The method of claim 1, further comprising, identifying, using the network controller, one or more TN cells neighboring one or more NTN cells.

3. The method of claim 1, wherein designating the one or more UEs as candidates for the handover to the NTN is based on a determination of a location, mobility pattern and trajectory of the one or more UEs.

4. The method of claim 1, wherein designating the one or more UEs as candidates for the handover to the TN is based on a determination of a location, mobility pattern and trajectory of the one or more UEs.

5. The method of claim 1, wherein the one or more NTN platforms comprises one or more satellites, one or more unmanned aerial vehicles, one or more manned aerial vehicles, and one or more high altitude platform stations.

6. The method of claim 1, wherein the NTN comprises supplemental coverage from space.

7. The method of claim 1, wherein activating the one or more NTN cells further comprises updating one or more NTN beam download/upload duty cycles, frequencies, carriers, NTN cell ephemeris information, and power settings.

8. The method of claim 1, wherein some of the one or more UEs correspond to one or more first responders and the one or more UEs corresponding to first responders are given priority to the one or more UEs that do not correspond to first responders.
